(19) United States
(12) Patent Application Publication
(10) Pub. No.: US 2008/0048831 A1
(43) Pub. Date: Feb. 28, 2008

(54) Method and Arrangement to Use a Rfid-Identifier for Recognition of Roll Ware

(75) Inventor: Pauli Tossavainen, Tampere (FI)

Correspondence Address: VENABLE LLP, P.O. BOX 34385, WASHINGTON, DC, 20043-9998, US

(73) Assignee: Top Tunniste OY, Tampere (FI)

(21) Appl. No.: 11/630,767

(22) PCT Filed: Jun. 2, 2005
(86) PCT No.: PCT/FI05/00252

§ 371 Date: Dec. 27, 2006

(30) Foreign Application Priority Data
Jun. 26, 2004 (FI) 20040895

(51) Int. Cl. H04B 7/00

(52) U.S. Cl. 340/10.1

(57) ABSTRACT

A method to use an RFId (Radio Frequency Identification)-identifier for recognition of roll ware, such as a roll of paper or like, whereby an RFId-identifier is being exploited that is to be placed essentially in connection with a core and which includes a transponder, being formed at least of a RFId-microcircuit and an antenna. For recognition of roll ware, a RFId-identifier is being used that is to be placed in connection with the core and that exploits a magnetic field, existing essentially uniformly all over the same in a radial direction. Also provided is an arrangement applying the method.

The invention relates to a method to use a RFId (Radio Frequency Identification)-identifier for recognition of roll ware, such as a roll of paper or like, whereby a RFId-identifier is being exploited that is to be placed essentially in connection with a core and which consists of a transponder, being formed at least of a RFId-microcircuit and an antenna.

Particularly paper companies have a common problem in identifying rolls of paper so, that a roll would get an unambiguous number that would last the whole lifetime of the roll even since the manufacturing phase. In this connection usually a bar code is being used nowadays for recognition of a roll or some other visual identifier or machine vision, which means in practice tags that are glued on the surface of a roll. These work well in principle, but in practice reading of the same is sometimes very difficult, which may derive from e.g. difficult placement of a tag or dirtiness of a tag. In final use this kind of tags will, however, be removed, when a protective board is being removed, whereafter it is not anymore possible to accomplish identification of the paper rolls in a so called machine assisted way.

On the other hand, in this context lately there have been solutions under development, by means of which the aim is to identify a paper roll by using RFId-techniques. Tests in practice have been accomplished by fastening inductive RFId-tags on the surface of a core in a way that they cover in maximum about half of the girth of the core. With this kind of solutions it is not, however, always possible to exploit the produced electromagnetic field, that is why neither an adequately reliable identification may be accomplished, because the electromagnetic field can not be read e.g. due to the tag being in a wrong orientation with respect to the electromagnetic field of the reader device.

It is the aim of the present method according to the invention to achieve a decisive improvement in the problems described above and thus to raise essentially the level of prior art. In order to achieve this aim the method according to the invention is mainly characterized in that for recognition of roll ware, a RFId-identifier is being used that is placed in connection with the core and that exploits an electromagnetic field, existing essentially uniformly all over the same in a radial direction.

As the most important advantages of the method according to the invention may be mentioned the simplicity and the reliability of its principle and the part entireties related to applying the same. Thanks to the method according to the invention, it is thus possible to take advantage of RFId-techniques, being advantageous as such, e.g. for recognition of rolls of paper, which is nowadays very problematic. Thanks to the method according to the invention, the paper rolls can be recognized ever since making of the housings or rolls all the way till their final use. The most important thing being the fact, that, when exploiting the method according to the invention, the recognition can always be accomplished in spite of the position of the paper rolls under each treatment process. As an advantageous embodiment of the method according to the invention, it is furthermore possible to repeat the electromagnetic field, exploited by the RFId-identifier, by using a repeating means that is external with respect to the roll ware. Thanks to the same, it is thus possible to make recognition of paper rolls even significantly more efficient in most heterogeneous processes.

Advantageous embodiments of the method according to the invention have been represented in the dependent claims related to the same.

The invention relates also to an arrangement to take advantage of the method described above. The arrangement is described in greater detail in the preamble of the independent claim related to the same and those mainly characteristic features of the same have been represented in the characterizing part of the corresponding claim.

As the most important advantages of the arrangement according to the invention may be mentioned the simplicity and the reliability of its construction and use, whereby e.g. identification of paper rolls or cores, which is nowadays very difficult to carry out, may be accomplished ever since putting together of the paper rolls all the way through the whole life cycle of the same. The ideal principle of the arrangement according to the invention is based on an electromagnetic field existing essentially uniformly all over the core in the radial direction and being exploited by an RFId-identifier belonging to the arrangement. With this solution as such, it is already possible to make the operation of a reader device significantly easier almost totally irrespectively of the position of the paper roll. As an advantageous embodiment of the arrangement according to the invention, it comprises furthermore a repeating means, existing essentially externally with respect to the roll ware, which repeats the electromagnetic field exploited by the RFId-identifier. When being carried out in this way, it is furthermore possible to make the recognition of paper rolls even significantly more efficient totally irrespective of the orientation of the paper rolls of any given time. The arrangement according to the invention intensifies thus significantly also work productivity thanks to the recognition of paper rolls getting significantly easier than nowadays.

Advantageous embodiments of the arrangement according to the invention have been presented in the dependent claims related to the same.

In the following description the invention is being depicted in greater detail with reference to the accompanying drawings, in which

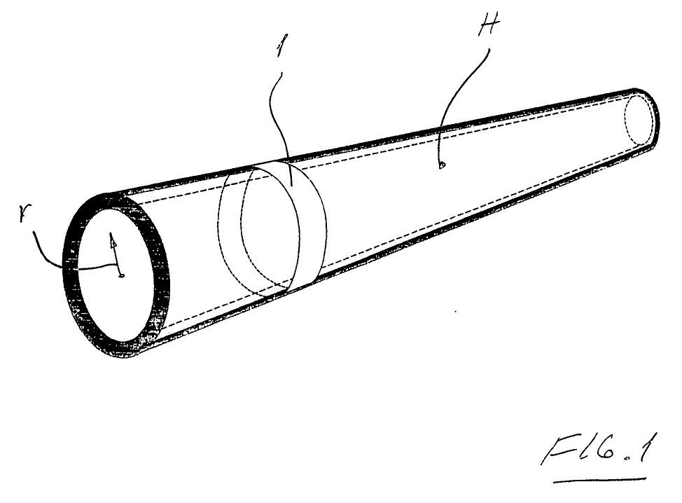

in FIG. 1
is shown as a perspective view one crucial implementation of the method according to the invention,

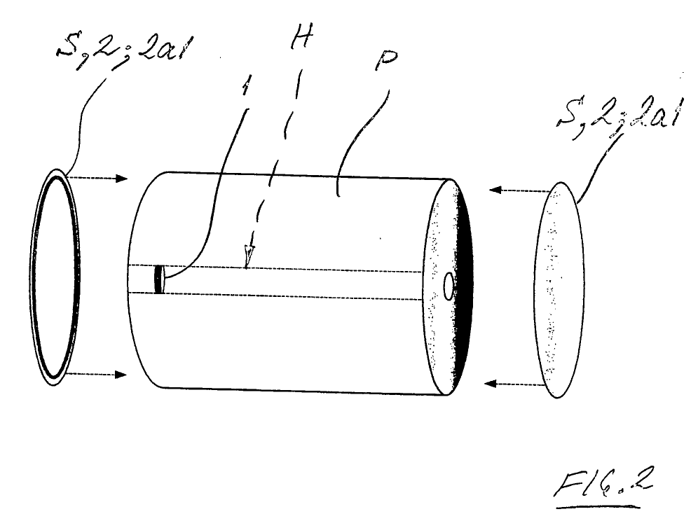

in FIG. 2
is shown an advantageous embodiment of the method according to the invention, whereby an external repeating means is being exploited,

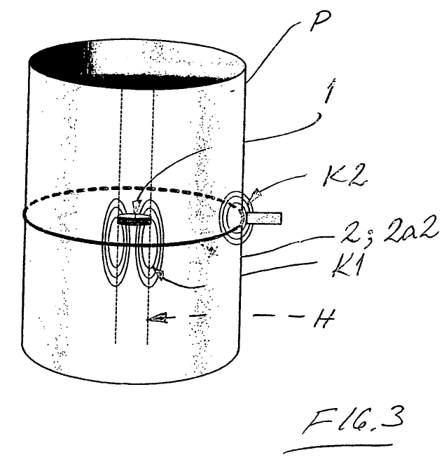

in FIG. 3
is shown the operating principle of the solution shown in FIG. 2 and

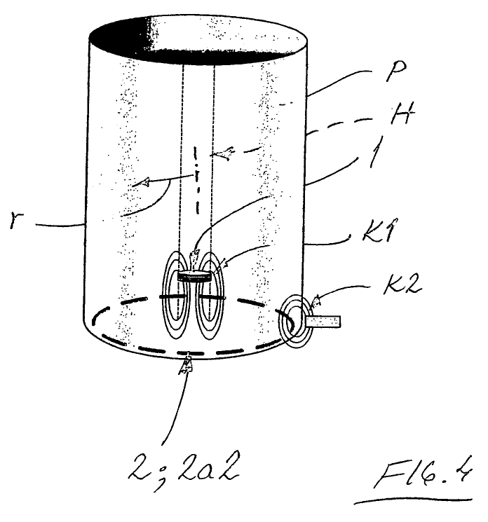

in FIG. 4
is shown furthermore the operating principle of an alternative embodiment with respect to the embodiment, shown in FIGS. 2 and 3.

The invention relates to a method to use a RFId (Radio Frequency Identification)-identifier for recognition of roll ware P, such as a roll of paper or like, whereby a RFId-identifier 1 is being exploited that is to be placed essentially in connection with a core H and which consists of a transponder, being formed at least of a RFId-microcircuit and an antenna. As shown in FIGS. 3 and 4, for recognition of roll ware, a RFId-identifier 1 is being used that is to be placed according to the principle, shown in FIG. 1, in connection with the core H and that exploits an electromagnetic field K1, existing essentially uniformly all over the same in a radial direction r. In this case, the magnetic field K1, exploited by the RFId-identifier 1 can be read by a magnetic field K2 on the principle, shown for example in FIGS. 3 and 4.

As an advantageous embodiment of the invention, the RFId-identifier, being used in the method, is formed of a transponder, being used as a RFId-actuator, whereby a RFId-microcircuit and antenna thereof are arranged, particularly in order to form an inlet, tag or like in an integral manner together with a flexible base layer, having a plastic based structure. Furthermore as an advantageous embodiment, in addition to a RFId-identifier 1, being in connection with a core H, an essentially external repeating means 2 with respect to the roll ware P is being used, which repeats the magnetic field K1 exploited by said RFId-identifier 1.

The repeating means 2 is being formed as an advantageous embodiment with reference for example to the solution shown in FIG. 2 of a spiral-, torus-like or alike electric wire arrangement 2a1, which is being provided in connection with a protective board S at one or both ends of the roll ware P.

As an alternative or complementing solution with respect to the above, the repeating means 2 is being formed with reference to the embodiment, shown in FIGS. 3 and 4, of a coil-, rim-like or alike electric wire arrangement 2a2, which is being arranged as a rim or like surrounding the roll ware from all over in the radial direction r.

The invention relates also to an arrangement for taking advantage of the method described above, which comprises on the principle shown e.g. in FIG. 1 a RFId-identifier 1 to be placed in connection with a core H, which exploits as shown in FIGS. 3 and 4 an electromagnetic field K1, existing essentially uniformly all over the same in a radial direction r.

The RFId-identifier being used in the arrangement consists advantageously of a transponder being used as a RFId-actuator, whereby a RFId-microcircuit and an antenna thereof are arranged particularly in order to form an inlet, tag or like in an integral manner together with a flexible base layer, having a plastic based structure. Furthermore as an advantageous embodiment, the arrangement comprises in addition to a RFId-identifier 1, being in connection with a core H, with respect to the roll ware P an essentially external repeating means 2, which repeats the magnetic field K1 exploited by said RFId-identifier 1.

With reference to the advantageous embodiment, shown in FIG. 2, the repeating means 2 is formed of a spiral-, torus-like or alike electric wire arrangement 2a1, which is placed either with separate structures or in an integral manner in connection with a protective board S at one or both ends of the roll ware. On the other hand as an alternative or complementing solution particularly with reference to the embodiment, shown in FIGS. 3 and 4, the repeating means is formed of a coil-, rim-like or alike electric wire arrangement 2a2, which is arranged as a rim or like, surrounding the roll ware from all over in the radial direction r.

Furthermore as an advantageous embodiment in practice, the RFId-identifier 1, surrounding the core H and/or the roll ware P from all over in the radial direction r, and/or the electric wire arrangement 2a2 comprise/comprises a circuit board, being printed in a plane, which is attachable in its place by means of a glue, tag surface and/or like existing therewith. On the other hand the RFId-identifier 1, surrounding the core H and/or the roll ware P from all over in the radial direction r, and/or the electric wire arrangement 2a2 may comprise a circuit board being printed in a plane and which may be wound around the core H and/or the roll of paper P, whereafter an electrically continuing electric circuit is achieved therein by coupling its wires with each other at its opposite ends.

It is clear, that the invention is not limited to the embodiments shown or described above, but instead it can be varied within the scope of the basic idea of the invention according to the needs and applications of any given time. Thus it is in the first place clear, that the structures related to both the RFId-identifier and also the repeating means may be carried out by very many kinds of solutions depending on under what kind of circumstances and with what kind of materials they have been coupled with. Thus, the actual RFId-identifiers as well as the repeating means can be arranged in a totally integrated manner during manufacturing of the protective papers and gable boards to be used for winding up of both the core and the paper rolls.

1. A method to use a RFId (Radio Frequency Identification)-identifier for recognition of roll ware, such as a roll of paper or like, whereby a RFId-identifier is being used that is to be placed in connection with a core and that comprises a transponder, being used as a RFId actuator, whereby a RFId-microcircuit and an antenna thereof are arranged particularly in order to form an inlet, tag or like in an integral manner together with a flexible base layer, having a plastic based structure, wherein in addition to a RFId-identifier, being in connection with a core and exploiting an electromagnetic field that exists essentially uniformly all over the same in a radial direction, with respect to the roll ware an essentially external repeating means is being used, which repeats the magnetic field exploited by said RFId-identifier.

2. The method according to claim 1, wherein the repeating means is being formed of a spiral-, torus-like or alike electric wire arrangement, which is being provided in connection with a protective board at one or both ends of the roll ware.

3. The method according to claim 1, wherein the repeating means is being formed of a coil-, rim-like or alike electric wire arrangement, which is being arranged as a rim or like that surrounds the roll ware from all over in the radial direction.

4. An arrangement to use of a RfiD (Radio Frequency Identification)-identifier for recognition of roll ware, such as a roll of paper or like, which arrangement comprises a RFId-identifier that is to be placed in connection with a core and that comprises a transponder, being used as a RFId-actuator, whereby a RFId-microcircuit and an antenna thereof are arranged particularly in order to form an inlet, tag or like in an integral manner together with a flexible base layer, having a plastic based structure, wherein the arrangement comprises in addition to a RFId-identifier, being in connection with a core and exploiting an electromagnetic field that exists essentially uniformly all over the same in a radial direction, with respect to the roll ware an essentially external repeating means, which repeats the magnetic field, exploited by said RFId-identifier.

5. The arrangement according to claim 4, wherein the repeating means is formed of a spiral-, torus-like or alike electric wire arrangement, which is placed either with separate structures or in an integral manner in connection with a protective board at one or both ends of the roll ware.

6. The arrangement according to claim 4, wherein the repeating means is formed of a coil-, rim-like or alike electric wire arrangement, which is arranged as a rim or like, surrounding the roll ware from all over in the radial direction.

7. The arrangement according to claim 4, wherein the RFId-identifier, surrounding the core and/or the roll ware from all over in the radial direction, and/or the electric wire arrangement comprise/comprises a circuit board, being printed in a plane and that is attachable in its place by means of a glue, tag surface and/or like existing therewith.

8. The arrangement according to claim 4, wherein the RFId-identifier, surrounding the core and/or the roll ware from all over in the radial direction, and/or the electric wire arrangement comprise/comprises a circuit board, being printed in a plane and which may be wound around the core and/or the roll of paper, whereafter an electrically continuing electric circuit is achieved therein by coupling its wires with each other at its opposite ends.
